(19) United States
(12) Patent Application Publication
(10) Pub. No.: US 2021/0346976 A1
(43) Pub. Date: Nov. 11, 2021

(54) WELDED SURFACE COATING USING ELECTRO-SPARK DISCHARGE PROCESS

(71) Applicant: Huys Industries Limited, Weston (CA)

(72) Inventors: Nigel Scotchmer, Willowdale (CA); Stephen Peterkin, Richmond Hill (CA)

(21) Appl. No.: 17/307,829

(22) Filed: May 4, 2021

Related U.S. Application Data
(60) Provisional application No. 63/020,393, filed on May 5, 2020.

(51) Int. Cl. B23K 11/00; B23K 11/20; B23K 11/24; B23K 11/18; B23K 11/34; B23K 35/00; B32B 15/01; B23K 35/30

(52) U.S. Cl. CPC B23K 11/0013; B23K 11/20; B23K 11/24; B23K 11/185; B23K 2103/26; B23K 35/004; B32B 15/01; B23K 35/3006; B23K 11/34

(57) ABSTRACT

A welded assembly includes a first object or substrate, an interlayer, and a subsequent layer deposited on the interlayer. The interlayer is an ESD coating deposited on the first object, and the subsequent layer is deposited by ESD on the interlayer. The subsequent layer is made of a different materials from the substrate. Both the interlayer and the subsequent layer are subject to peening. In one case the interlayer has a lower either a lower thermal conductivity or a lower electrical conductivity than the substrate and the subsequent layer. In another example, the subsequent layer has a cermet content of greater than 40% by wt.

This application claims the benefit of priority of U.S. Provisional Patent Application 63/020,393 filed May 5, 2020, the specification and drawings thereof being incorporated herein in their entirety by reference.

### FIELD OF THE INVENTION

This specification relates to the field of welding using electro-spark discharge.

### BACKGROUND

In some manufacturing processes it may be desirable to make a weld between materials that are not easily welded. It may be that the materials are difficult to weld because their own thermal conductivity or electrical conductivity, or both, is very high. In other circumstances, it may be difficult either because the materials themselves are not amenable to welding because they have physical properties that will be impaired by the welding process, or because they include allowing compositions that have dispersed non-homogenous elements, or that have compositions that would be altered by welding.

Electro-Spark Discharge (ESD) welding is a process by which the surface of an object may be treated or coated with a deposited material. A premise of ESD is that the work piece is electrically conductive. One terminal of an electrical discharge apparatus is connected to the work piece (or to a fixture in which the work piece is held to form an electrically conductive path), and another terminal of opposite polarity is connected to a moving electrode holder. The moving electrode holder is used to cause an electrode to approach the work piece. Material from the electrode is deposited on the work piece when an electrical arc passes between the electrode tip and the work piece. In this process the electrode is consumed, bit-by-bit with each spark discharge. The energy of each individual discharge is small, typically less than 2 J.

By its nature, ESD allows the welding of sometimes highly dissimilar materials under what might be otherwise challenging conditions. As the process recurs repeatedly, the surface of the work piece is progressively covered, or coated, in the deposited material. The nature of the spark discharge is such that a true weld of fused and mixed materials is formed between the parent material of the work piece and the deposited material of the welding rod. The depth of that weld is small. Since the amount of heat is also small, the heat affected zone (HAZ) is also very small, to the point where the ESD process may be thought of as producing no heat affected zone.

### SUMMARY OF THE INVENTION

In an aspect of the invention there is a method of coating a substrate, the substrate being electrically conductive. The method includes coating a first region of the substrate with an electro-spark discharge (ESD) coating of a material that is different from the substrate to form an interlayer; coating the interlayer with a subsequent layer of a material that is different from the interlayer; and peening at least one of (a) the interlayer; and (b) the subsequent layer as part of the coating process.

In a feature of that aspect, the interlayer and the subsequent layer are peened. In another feature, the interlayer is deposited using polarity-switching AC. In still another feature, the subsequent layer is deposited using direct current electrode positive. In another feature, at least one of the interlayer; and the subsequent layer is made of at least a first sub-layer and a second sub-layer of material deposited by ESD on the first sub-layer. In another feature, the interlayer is a first layer, the subsequent layer is a second layer, and a third layer is deposited by ESD on the second layer. In another feature, the substrate is predominantly copper, and the subsequent layer is made using a welding rod deposition material that is predominantly silver. In yet another feature, the substrate is made of a material that is a steel alloy, and the subsequent layer includes tungsten carbide. In another feature, the interlayer is made using a welding rod deposition material that is one of (a) nickel; and (b) an alloy whose dominant constituent by wt. % is nickel. In a further feature, a shielding gas is used in the deposition of at least one of (a) the interlayer; and (b) the subsequent layer. In still another feature, the first object is made of a first material; the subsequent layer is made of a second material; the electro-spark discharge coating is made of a material that is different from the first material; and the electro-spark discharge coating is made of a material that is different from the second material. In still another feature, the second material differs from the first material. In another feature, the first object is a steel alloy. In still another feature, the first object is made of a steel alloy and the second material is a cermet. In a further feature, the first object is made of a copper alloy and the second material is one of silver or aluminum. In still another feature, the substrate is made of a first material, the interlayer is made of a second material, and the subsequent layer is made of a third material; the first and third materials have higher thermal conductivities than the second material. In yet another feature, the second material has a thermal conductivity of less than 100 W/MK. In another feature, the first and third materials have thermal conductivities of greater than 100 W/MK. In a further feature, the first and third materials have thermal conductivities greater than 150 W/MK. In another feature, the method includes coating of the first object includes making more than one pass of electro-spark discharge deposited material on the first object to build a coated region of a set thickness. In a yet further feature, the method includes making at least a first layer and a second layer of electro-spark discharge deposited material on the first object, the first layer being made of a different composition of material than at least one subsequent layer. In still another feature the method includes forming at least a second electro-spark discharge coated region on the first object, and subsequently welding another subsequent layer of a different material to the second electro-spark discharge coated region. In another feature, the method is used to form either a silver-rich or an aluminum-rich surface coating on a copper substrate of an electrical contact. In an alternate feature, the method is used to form a tungsten carbide rich surface layer on a steel alloy.

In another aspect there is a welded assembly. It has a first material; a second material; and an electro-spark discharge interlayer. The electro-spark interlayer is formed on the first material. The second material being deposited by ESD on the interlayer. The interlayer having a peened surface; and the second layer having a peened surface.

In a feature of that aspect the second material is welded to the electro-spark interlayer by electro-spark discharge welding and the weld is free of a heat affected zone. In another feature the first material is different from the second material. In still another feature, the electro-spark interlayer has a different composition from the first and second materials. In another feature, the first object is a stainless steel alloy. In a further feature, the coating of the first object includes more than one pass of electro-spark discharge deposited material on the first material to build a coated region of a set thickness. In still another feature, the interlayer is subject to peening, and the peening includes impacting the first region with a mean impact density in the range of between 0 and 30,000 impacts per cm. In another feature, the mean impact density is in the range of 3,000 and 20,000 impacts per cm. in still another feature, the substrate is a work piece formed of a material that includes at least one of (a) Nickel; (b) Chromium; (c) Molybdenum; (d) Titanium; (e) Tungsten; (f) Niobium; (g) Iron; (h) Aluminum; and (i) Copper; (j) Magnesium; and (k) Cobalt. In another feature, the substrate, by weight is at least one of (a) 10% Nickel; (b) 5% Chromium. In another feature, the substrate, by weight is at least one of (a) at least 90% Copper; (b) 90% Steel. In yet another feature, the second material, by weight is at least one of (a) 90% silver; (b) 90% Aluminum; and (c) 40% Tungsten Carbide. In another feature, the work piece is made of a metal alloy of which Nickel and Chromium are the largest constituents by wt. %. In yet another feature, the interlayer is formed of an alloy that, by weight, has a higher percentage of Nickel than any other constituent. In a further feature, iron is, by wt. %, the largest component of the alloy of the substrate. In still another feature, the interlayer includes a second ESD coating applied on top of the first ESD coating. In yet another feature, the material deposited in the second ESD coating is different from the material deposited in the first ESD coating. In another feature, the welded assembly is an electrical contact, the first material is predominantly copper, and the second material is silver or an alloy of silver. In an alternate feature, the first material is a steel, and the second material includes tungsten carbide deposited to form a wear surface on the steel.

These and other features and aspects of may be understood with the aid of the detailed description and drawings that follow.

### BRIEF DESCRIPTION OF THE DRAWINGS

FIG. 1 is a plan view of a substrate upon which a set of interlayer coating footprints is deposited by ESD;

FIG. 2a is a cross-sectional view of an assembly such as that of FIG. 1 showing a weldment layers located between the first object to be welded;

FIG. 2b is an alternate embodiment of assembly to that of FIG. 2a having an interlayer and an outer deposited layer, one laid down upon another;

FIG. 2c shows a second object or layer has been built up upon the first interlayer and the second deposited layer of FIG. 2b;

FIG. 2d shows a third object or layer has been built up upon the first interlayer, the second deposited layer, and second object of FIG. 2c;

FIG. 3 shows an alternate embodiment in which a first interlayer is established on a first object to be welded, and filets of electro-spark deposited material are built up between the interlayer coating and the second object to be welded;

FIG. 4 shows a schematic of a polarity switching apparatus for making the filet welds of FIG. 3.

### DETAILED DESCRIPTION

The description that follows, and the embodiments described therein, are provided by way of illustration of examples of particular embodiments of the principles of the present invention. These examples are provided for the purposes of explanation, and not of limitation, of those principles and of the invention. In the description, like parts are marked throughout the specification and the drawings with the same respective reference numerals. The drawings are substantially to scale, except where noted otherwise, such as in those instances in which proportions may have been exaggerated to depict certain features. In that regard, this description pertains to the deposition of a layer, or multiple layers, of a welded coating by electro-spark discharge. In general, these layers tend to be of the order of a few tens of μm thick, e.g., 20 μm to 200 μm, and may tend not to exceed 2 mm in thickness. Accordingly, the thicknesses shown in the layers and the fillets of the various illustrations may be greatly exaggerated for the purposes of conceptual understanding.

In this description may use multiple nouns to provide nomenclature for the features. The multiple nouns are used as synonyms, and the detailed description is used as a thesaurus to convey understanding at both the specific level and at the broader conceptual level. English often has many words for the same item, and where multiple terminology is provided, it shows that synonyms for the item are within the understanding of the feature, and that it is not limited to one particular noun.

In terms of establishing process context, FIG. 1 shows a first member, or first object to be welded, however it may be called, identified as a substrate 20. This nomenclature of a “substrate” is intended to refer to any first object to be welded, whether it is flat or curved, thin or thick, whatever its profile may be, and whatever appearance it may have in plan form. In that context “substrate” is intended to be generic, unless indicated otherwise. There is a welded layer or covering, or stratum, or deposition, which is given the nomenclature coating 30. The nomenclature “coating” is likewise intended to be generic.

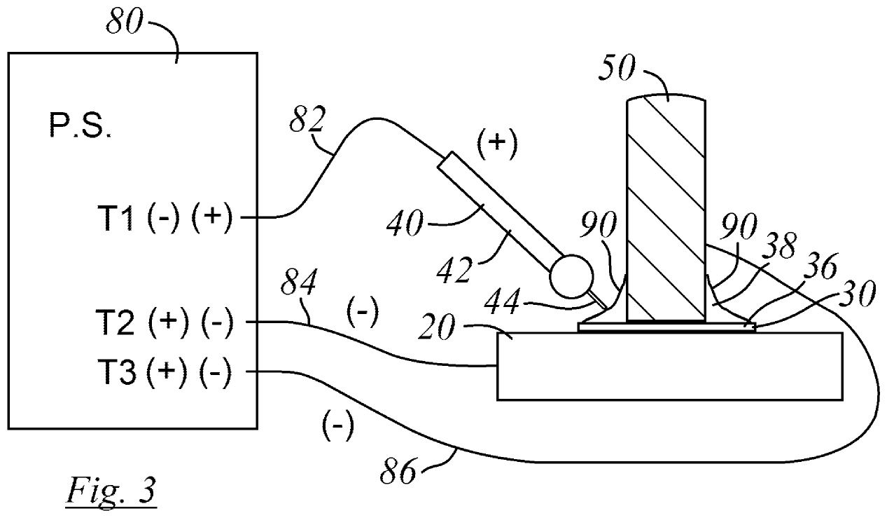

Coating 30 has been deposited on substrate 20 by an electro-spark discharge (ESD) process using an ESD welding applicator. One kind of ESD welding applicator 40 is indicated in FIG. 3 as having electrode fixture or holder 42 and an electrode rod 44. Electrode rod 44 is a consumable welding rod. Whether hand-held or held by a robot, the terms “electrode” and “electrode applicator” are also intended to be generic. Where it is held by a robot, the robot may be programmed to lay down coating 30 according to a particular pattern or footprint on substrate 20. As suggested by the various different shapes of coating pattern 51, 52, 53, 54, 55 indicated in FIG. 1. The welding rod 44 held by applicator 42 may be of constant diameter, and may in some instances be of relatively small diameter, such as a few millimeters, e.g., 1.5 mm, 1.8 mm, and so on. When welding rod 44 is consumed, it is replaced with a new consumable welding rod. The composition of welding rod 44 is chosen to suit the application. By the nature of the ESD deposition process, applicator 40 is subject to vibration, whether due to a mechanical oscillator such as a rotating or reciprocating imbalance weight, or due to an ultrasonic vibrator. The voltage of discharge, the frequency of discharge, the duration of discharge, the capacitance of the discharge, or all of them, are parameters that are subject to adjustment and selection according to the materials to be welded, and the thickness of coating to be applied. In the process of depositing coating 30, vibration may be applied to substrate 20, whether or not welding applicator 40 is in contact with it. Welding may occur with or without shielding gas. The shielding gas, when used, may be a non-participating gas such as

Argon or Neon.

In ESD, welding rod 44 may be made of a wide variety of compositions of materials, and may be made by a sintering process. Otherwise difficult to obtain concentrations of substances may sometimes be obtained, as when welding cermet coatings on metals, such as TiC or TiB2, or WC. For example, in obtaining a tungsten-carbide coating, the welding rod may be made of a composition that combines Cobalt, Nickel, or Austenitic Steel with the Tungsten Carbide as powder when making the rod.

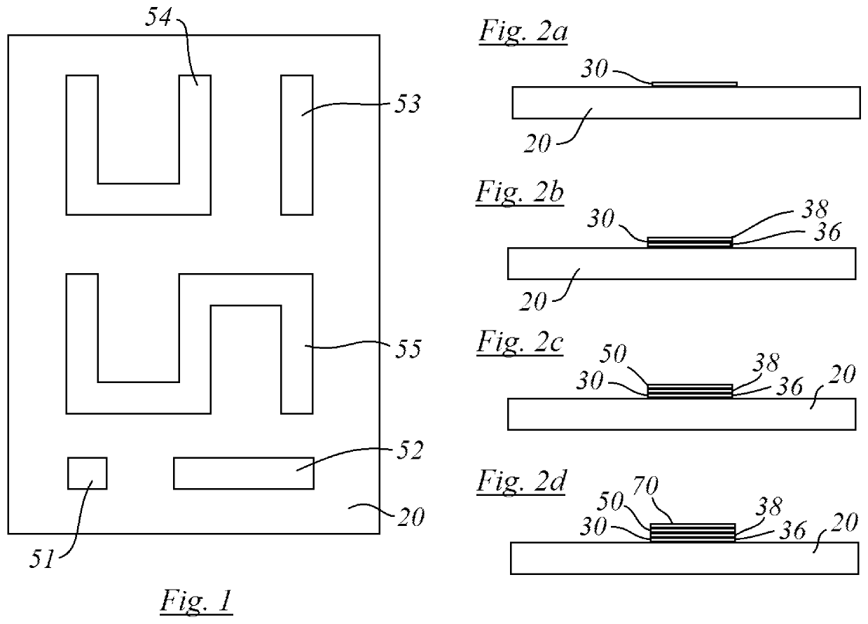

In FIG. 2a only a single layer coating 30 is formed on substrate 20. In some circumstances this may be sufficient. In one example herein, coating 30 may be a silver coating applied to a copper substrate by ESD. In the past, the welding of silver to copper by more conventional processes has been found to be a challenge because of the very high thermal conductivity and electrical conductivity of both silver and copper. However, the present inventor has been able to deposit a silver coating on copper using an ESD process.

In other examples, the single layer coating 30 of FIG. 2a can also be seen as a first or intermediate step in the formation of a multi-layer deposition. Accordingly, In FIG. 2c there is a second layer 50. It is another ESD layer applied to coating 30 after coating 30 has been applied to substrate 20. A subsequent weld 60 is then formed between second layer 50 and the first layer, coating 30. That is, there is a first weld made by an ESD deposition process between the material of coating 30 and substrate 20; and a second weld made between second layer 50 and the first layer defined by coating 30.

In these items, substrate 20 may be any kind of work-piece that is electrically conductive and upon which a welded ESD coating can be deposited. In particular, substrate 20 may be made of a material that may otherwise be difficult to weld, or that may be difficult to weld to the particular material of which second object 50 is made. This may occur even where the first and second materials are the same, but where a coating of the material may make welding problematic for one reason or another; or where the weld would cause precipitation of elements in the metal alloy that are perhaps better left dispersed in solution.

In one example, substrate 20 is a terminal block made of copper. It may be a terminal block of high electrical and thermal conductivity, and, as such, may be nearly pure copper. In another example herein, substrate 20 is a steel alloy to which a hardened surface coating is applied. Alternatively, and particularly where one metal or metal alloy has a significantly lower melting point temperature than the other, were customary arc welding used, one material would tend to melt and to form a liquid pool much more readily than another, with a larger HAZ, and more opportunities for items in both solutions to join and form undesired compounds (e.g., ceramic or intermetallic particles) at the weld interface. Or, it may facilitate the precipitation of alloying elements (that had been in solution) into larger coalesced particles, which may led either to brittleness or to loss of alloy strength. By contrast, an ESD coating forms with very low energy input per discharge. The deposited metal of welding rod 44 fuses with the base metal of substrate 20 in a true welded bond, but not enough energy is used to cause alloys in solution to precipitate significantly, if at all, and the physical region affected by the weld is of the order of a few tens or scores of μm thick. There is no liquid weld pool, and the time duration of the spark discharge to make the weld is small, typically of the order of a millisecond or less.

That is, in some examples, coating 30 may be chosen of a material that welds relatively easily to the material of substrate 20, and that welds relatively easily to the material of second layer 50. For example, substrate 20 may be made of a steel, such as a stainless steel, and the material of coating 30 may be of nickel or a nickel-based alloy. Second layer 50 may be made of a more difficult material to weld, for whatever reason.

The use of an ESD coating may also allow coating 30 to have a specific footprint sized and configured to match a particular use, e.g., as an electrical contact or as a wear surface. Various footprints are shown in FIG. 1 as footprints 51, 52, 53, 54, 55. These footprints need not be purely rectangular, but may be have legs or portions that form extended shapes, such as the U-shape of footprint 54 or the S-shape of footprint 55. This permits coating 30 to be discontinuous, which is to say there may be a sub-region or plural regions of coating 30 (or coatings 30), and such other coated regions as may be, that are separate and distinct from each other. These multiple regions may each provide an interlayer for a unique second layer 50.

Furthermore, coating 30, being an ESD coating, is such that the thickness of coating 30 can be controlled by controlling the quantity of deposited materials, or by making repeated coatings, or both. As indicated in FIG. 2b, coating 30 may include a first coating layer 36 that is made of a first material, or first alloy, and a second coating layer or second coating alloy 38 that is of a different material or different composition of matter. In some embodiments, the first and second layers 36 and 38, may be of the same deposited material of rod 44, built up in multiple stages or passes or sub-layers. The first material, of layer 36, may be compatible with the material of substrate 20. The second material, of layer 38 may be compatible with the first material, and also compatible with the material of a further additional layer, such as that of a second object 50. As discussed below, although reference is made to first layer or sub-layer 36 and second layer or sub-layer 38, there may be more than two layers, and each layer may have two or more sub-layers, as may suit.

Welding electrode applicator 30 may be as shown and described in U.S. patent application Ser. No. 15/856,146, of Huys Industries Ltd., published as US Publication 2018/0 178 308 A1 on Jun. 28, 2018, the specification and drawings thereof being incorporated in their entirety herein by reference. In each case, the welding electrode is sized to be suitable for access to and use with the surface 24 in question.

As noted above, a premise of ESD coating processes is that the work piece is, or work pieces are, electrically conductive, and is (or are) connected to a respective terminal of a welding power supply 80. That is, a first terminal of power supply 80 is connected by a conductor such as wire or cable 82 to welding applicator 40. In this case the work pieces are, first, substrate 20, and latterly second layer or coating 50, third layer or coating 70, and so on, however many there may be as in FIG. 2d. Equally, work piece 20 may be mounted in an electrically conductive jig or fixture connected to power supply 80, as indicated notionally by connecting cable 84. Obviously, the terminal to which cable 84 is connected will, in operation, be of opposite polarity to the terminal to which cable 82 is connected. Whether directly or indirectly, substrate 20 and power supply 80 are in electrical connection to form a continuous path for electric current. Similarly, as noted, power supply 80 may have another output terminal connected to welding applicator 40 to form a continuous electrical path to welding rod 44 of opposite electrical polarity to work piece 20 such that an arc will be formed between them when they approach. During operation applicator 40 may be, and in the embodiment shown is, subject to an oscillation forcing function that causes it to vibrate, which in turn causes vibration of rod 44 against work piece 20, rapidly making and breaking contact therewith. This forcing may be provided by a rotating mechanical imbalance, or it may be provided by an ultrasonic vibrator, for example as shown and described in U.S. patent application Ser. No. 15/856,146. In either case, the deposition process may include peening the coating, or any layer or sub-layer of the coating, with the end of the applicator rod when electricity is not being discharged, e.g., intermittently between discharges or after discharge during cooling, to yield a finer grain structure and an even coating; and, additionally or alternatively, it may be shaken, as by induced vibration applied to substrate 20 either directly or through its jig to cause finer grain structure to form during cooling.

In one example, substrate 20 may be made of Inconel 718. In each example, a surface covering, or layer or treatment, includes a layer 30 that has been deposited with welding applicator 40 on surface 24 of substrate 20. As noted above, layer or coating 30 can be made of the same material as work piece 20. Alternatively it can be made of a different material having particular properties selected for suitability with the material of work piece 20. Coating 30 may be, or may include, material such as nickel that has a high affinity for other metals, and that provides an intermediary to which a further layer or sub-layer 36 or 38, or second layer or object 50, may be applied that is of a different material that may be less compatible with the underlying material of substrate 20, but that is nonetheless compatible with the intermediate layer defined by coating 30. That is, coating 30 is intermediate work piece 20 and second object 50.

As noted above, in some instances such as the application of a silver or aluminum surface on a copper substrate, coating 30 may a single layer, applied alone. However, in other instances, the process of depositing a layer of coating 30 includes a first step or portion of deposition, and a second step or portion of peening of the coating on surface 24. The peening process may tend to occur while the underlying metal is still hot, and therefore relatively soft and susceptible to plastic deformation. That plastic deformation due to peening tends to flatten asperities in the surface, and the resultant deformed, coated surface may tend to have a reduced tendency to develop crack initiation site.

During ESD, the tip of welding electrode rod 44 is in intermittent contact with the work surface, and that intermittent contact tends to have a mechanical hammering effect on the surface being coated. When electrical current is flowing, an arc will form and material of rod 44 will be deposited in a molten form on surface 24. There will also be local heating due to the heat of the electric current discharge. Each electrical contact results in a low energy local discharge heating of, for example, less than 10 J. Typically the discharge at one point of contact is of the order of 1 J-2 J. When the electrical discharge current is turned off, the tip of electrode rod 44 may continue repeatedly to contact the surface according to the vibration forcing function as welding applicator 40 oscillates, without further material discharge occurring. This non-electrical discharge contact, when current is not flowing, provides the peening step. The electrical discharge step may involve the switching on and off of current over relatively short time periods on the order of one or two milliseconds. This switching is achieved with programmable power supply 80. Similarly, the time period when electrical discharge current is off may be quite short, again, of the order of one or two, or a few, milliseconds. The switching “On” and “Off” may occur rapidly and repeatedly such that while the steps of discharging and peening may be distinct, and cyclic, to a human observer it may appear that they are occurring at the same time, and that they are continuous.

In some instances, the ESD discharge coating and peening process may occur in a non-participating environment. That is, the process may be performed in a vacuum chamber or it may be performed in a chamber that has been flushed with a non-participating gas, such as an inert gas such as neon or argon, or a non-oxidizing gas, such as carbon dioxide.

In some instances, the coating may be deposited, and then the process of coating may be followed by mechanical peening while electrical discharge is not occurring. In other instances it may be deposited without mechanical peening. In either case the coating process, with or without peening, may be followed by one or more steps of post-process heat treatments. Depending on the nature of the alloy from which the work piece is formed, heat treatment may be employed to promote a precipitation hardening effect. Although the composition of Inconel 718 and Hastelloy X are similar, Inconel 718 displays higher hardness and fatigue resistance. In combination with the reduced surface roughness and compressive residual stresses as a result of ESD and mechanical peening, the surface and fatigue properties of LPBF Hastelloy X parts may be improved significantly. While a separate peening tool could be used in come embodiments, it is convenient to use electrode rod 44 as the peening tool, with the electrical current interrupted.

In the first example, where it is desired to put a silver coating on copper, coating 30 may be a single coating, and that coating may be silver. However, it may be that a more consistent silver surface can be obtained by using ESD first to deposit nickel on the copper; and then, afterward, to use ESD to deposit a layer of silver on the layer of nickel. That is, it may be easier to lay a layer of silver down on a layer of nickel, or on a nickel alloy, than to put a layer of silver directly on the copper. While it is possible to deposit silver directly on copper, it is also possible to use a two-step process of laying the nickel down on the copper, first, and then laying the silver down on top of the nickel.

This can be expressed a different way. In this example, the first object is made of a material of high electrical conductivity and also a high thermal conductivity; the interlayer (or at least one of the interlayers or sublayers) is made of a material that has a lower electrical conductivity, and a lower thermal conductivity, than the material of the first object. The subsequent layer that is laid down on top of the first coating is made of a material that is of a higher electrical conductivity, and a higher thermal conductivity, than the first coating layer, i.e., than the interlayer. In the case of laying down a silver surfacing or aluminum surfacing on a copper substrate, both the base material (copper) and the surfacing material (silver or aluminum or gold) are very high electrical conductivity materials and also very high thermal conductivity materials, and have higher electrical conductivity than nickel, and a higher thermal conductivity than the intermediate material, such as, nickel. That can also be expressed by saying that the intermediate material has a thermal conductivity of less than 100 W/MK, whereas the base material and the subsequent layers have thermal conductivity of greater than 100 W/MK. In some embodiments, the thermal conductivity of one or both of the first object and the subsequent layer are greater than 150 W/MK, and, as in the case of either substantially pure aluminum or silver on copper, all have thermal conductivities of over 200 W/MK whereas Nickel is less than 100 W/MK.

It may be noted that once the layer of nickel has been laid down, a second layer, or sub-layer of nickel can be laid down on top of the first layer of nickel. The thickness of the nickel layer can be increased by laying down subsequent layers or sub-layers as well. Similarly, once a satisfactory interlayer of nickel has been established, in however many passes or layers or sub-layers, so as to be coating 30, the layer of silver can itself be laid down as a second layer, such as may be second object 50, which made of successive passes of layer or sub-layers of ESD deposited silver.

It should also be noted that when this description speaks of a “layer” or “sub-layer”, the deposited material once laid down does not form a homogenous, pure, layer of deposited material of rod 44 on a distinct and homogenous layer of the base metal of the parent material of substrate 20. On the contrary, a layer, such as a layer of coating 30 tends to mix with the material of substrate 20 during the ESD process, such that there is a variation in the concentration of the components of the resultant layer as there is a mixing effect during ESD. The overall thickness of a layer such as coating 30 may be as little as 20 μm, or as great as 100 to 200 μm, depending on conditions. A thicker layer can be built up using multiple sub-layers of successive deposition. However, taking an affected layer as being of the order of 60 to 100 μm thick, on the inner portion of the metal matrix the composition may be essentially the same as that of substrate 20. Moving from the interior of substrate 20 toward the surface of coating 30, the concentration of the material of substrate 20 falls, and the concentration of the deposited material of welding rod 44 rises.

In the first example, a series of test was undertaken in respect of providing surfacing for a copper contact block. Silver, aluminum, nickel, and brass were considered as possible surfacing materials. The context of these trials was to use ESD to deposit various coatings on electrical switches, whether of copper, silver, nickel or aluminum or alloys of them. The intention is that the switch surface may then gain beneficial properties of the coating such as arcing resistance, low contact resistance, improved electrical conductivity, erosion resistance, oxidation resistance or other properties. Trials were done in a roughly 1 cm² area for about 2 minutes of coating time, not including the time for peening. Summary of the analysis of the metallurgical cross sections and microstructure measurement data shows that: (a) Ag coatings without peening tended to result in delaminated, or poorly bonded coatings. It was, however possible to achieve relatively high deposition rates. Deposition with peening was more promising. (b) Ni and Ag coatings without shielding gas resulted in higher deposition rates. Visual inspection of micrograph images did not demonstrate poorer adhesion, cracks, voids or other defects due to the lack of shielding gas with Ni. Some bands of discolouration, indicating oxide layers, were visible. (c) Qualitatively, the direct examples of Ag on Cu coatings (Trials 5-12) showed significant erosion of the copper substrate. While relatively thick coatings were achieved in the sense of effective weld depth, the net buildup to the surface was low in terms of accretion thickness beyond the original substrate thickness. (d) Layered Ag+Ni coatings resulted in significantly thicker coatings than those with only the Ni base layer. (e) Direct-Current Electrode Polarity (DCEP) was effective to deposit coatings on Ni coatings. (f) AC75 polarity was effective for depositing Ag coatings. (g) Brass coatings potentially oxidized and eroded the Cu substrate resulting in zero net coating.

The use of a two-stage coating process using one or more interlayers may aid in the deposition on, or surfacing of, a metal substrate with cermet materials. It is possible to deposit some of these relatively difficult cermet materials on steels by other welding processes, such as oxy-acetylene, MIG or TIG. However, the use of ESD may tend to permit a coating to be made in a low energy input process, and may permit high cermet concentrations in the range of greater than 40% concentration by weight, and up to the range of 60% to 70% by weight. An example of an application of this technology is in the facing of metals. An object may be made of one grade of steel, for example, and it may be desired for that object to have a hardened surface area. The establishment of a cermet surface on the base metal may then provide either an enhanced cutting ability, or may provide a hardened wear surface. ESD allows this to be done with a close to near-net-size coating over a known footprint, with control over deposition per unit area.

TABLE 1
Cross section measurements and trial conditions

| | | Average | | | | | | |
|---|---|---|---|---|---|---|---|---|
| | | coating | | Max | Min | | | |
| | | thick- | | thick- | thick- | | | |
| Trial | Coat- | ness | St. Dev. | ness | ness | Time | | Peen- |
| Number | ing | (um) | (um) | (um) | (um) | (s) | Ar | ing |
| TRIAL 1 | Ni | 26.64 | 7.93 | 36.08 | 14.86 | 129 | N | Y |
| TRIAL 2 | Ni | 15.47 | 6.56 | 27.90 | 4.47 | 124 | Y | Y |
| TRIAL 3 | Ag + | 45.60 | 11.69 | 65.73 | 24.47 | 123 | N | Y |
| | Ni | | | | | | | |
| TRIAL 4 | Ag + | 34.71 | 12.41 | 60.43 | 11.78 | 121 | Y | Y |
| | Ni | | | | | | | |
| TRIAL 5 | Ag | 48.78 | 24.65 | 81.20 | 3.44 | 120 | N | Y |
| TRIAL 6 | Ag | 37.88 | 14.56 | 57.16 | 18.58 | 129 | Y | Y |
| TRIAL 7 | Ag | 50.43 | 7.84 | 67.10 | 41.28 | 120 | N | N |
| TRIAL 8 | Ag | 45.63 | 20.42 | 81.54 | 15.89 | 120 | Y | N |
| TRIAL 9 | Ag | 43.98 | 10.14 | 61.64 | 20.94 | 125 | Y | Y |
| TRIAL 10 | Ag | 31.84 | 7.11 | 46.12 | 19.85 | 120 | Y | Y |
| TRIAL 11 | Ag | 41.15 | 16.10 | 63.42 | 16.86 | 121 | Y | Y |
| TRIAL 12 | Ag | 35.88 | 13.17 | 62.69 | 16.51 | 120 | Y | Y |
| TRIAL 13 | Brass | 31.66 | 13.99 | 57.00 | 6.62 | 119 | Y | Y |
| TRIAL 14 | Al | 81.43 | 32.37 | 138.00 | 11.02 | 98 | Y | Y |
| TRIAL 15 | Ni | 29.42 | 8.86 | 49.21 | 10.67 | 78 | Y | Y |

TABLE 2
Cross section measurements and ESD parameters

| | | Average | | Voltage | Capacitance | Frequency | | Power |
|---|---|---|---|---|---|---|---|---|
| Trial | Coating | (um) | Max (um) | (V) | (uF) | (Hz) | Polarity | (W) |
| 1 | Ni | 26.64 | 36.08 | 140 | 390 | 107 | AC75 | 409.0 |
| 2 | Ni | 15.47 | 27.90 | 140 | 390 | 106 | AC75 | 405.1 |
| 3 | Ag + Ni | 45.60 | 65.73 | 140 | 200 | 105 | AC75 | 205.8 |
| 4 | Ag + Ni | 34.71 | 60.43 | 140 | 200 | 103 | AC75 | 201.9 |
| 5 | Ag | 48.78 | 81.20 | 140 | 130 | 201 | AC75 | 256.1 |
| 6 | Ag | 37.88 | 57.16 | 140 | 130 | 201 | AC75 | 256.1 |
| 7 | Ag | 50.43 | 67.10 | 140 | 130 | 201 | AC75 | 256.1 |
| 8 | Ag | 45.63 | 81.54 | 140 | 130 | 201 | AC75 | 256.1 |
| 9 | Ag | 43.98 | 61.64 | 140 | 390 | 60 | AC75 | 229.3 |
| 10 | Ag | 31.84 | 46.12 | 140 | 90 | 251 | DCEP | 221.4 |
| 11 | Ag | 41.15 | 63.42 | 140 | 390 | 101 | DCEP | 386.0 |
| 12 | Ag | 35.88 | 62.69 | 100 | 280 | 201 | DCEP | 281.4 |
| 13 | Brass | 31.66 | 57.00 | 100 | 330 | 201 | DCEP | 331.7 |
| 14 | Al | 81.43 | 138.00 | 100 | 330 | 201 | DCEP | 331.7 |
| 15 | Ni | 29.42 | 49.21 | 140 | 390 | 98 | DCEP | 374.6 |

Table of Results, based on scanning electron
microscope (SEM) analysis of weld samples

| | AVR. | EFFECTIVE | |
|---|---|---|---|
| TRIAL | Ag | Ag | |
| # | wt % | DEPTH (um) | PARAMETERS |
| 5 | 50 | 29 | Ag + Cu AC75 w/Ar; w/peening |
| | | | [140 V; 130 uF; 200 Hz] |
| 6 | 35 | 33 | Ag + Cu AC75 wo/Ar; w/peening |
| | | | [140 V; 130 uF; 200 Hz] |
| 7 | 50 | 50 | Ag + Cu AC75 w/Ar; wo/peening |
| | | | [140 V; 130 uF; 200 Hz] |
| 8 | 40 | 65 | Ag + Cu AC75 wo/Ar; wo/peening |
| | | | [140 V; 130 uF; 200 Hz] |
| 9 | 45 | 27 | Ag + Cu; DCEP; w/Ar; w/peening |
| | | | [140 V; 390 uF;6 0 Hz] |
| 11 | 25 | 75 | Ag + Cu; DCEP; w/Ar; w/peening |
| | | | [140 V; 390 uF; 105 Hz] |
| 12 | 65 | 45 | Ag + Cu; DCEP; w/Ar; w/peening |
| | | | [140 V; 290 uF; 200 Hz] |

Of the tests made with only silver on copper (i.e., without a nickel interlayer), Trial 12 showed the highest overall Ag content, and coating effective thickness based on Ag content. In optical images, Trial 8 had average Ag content and a large effective thickness, yet was of less satisfactory quality due to lack of peening. Also, from these results, high Ag content correlated to use of shielding gas, in this case Argon.

DCEP output as seen in Trial 11 showed significant penetration and diffusion, as the average Ag content was less than Trail 9 with similar parameters, but a larger effective coating thickness.

The transition in concentration may be relatively abrupt. That is, in one example, the concentration of nickel was about 5 wt. % 1-10 wt. % at the inner edge of the weld, and 30 wt. %-35 wt. % near the surface of the weld, whereas the concentration of copper was more than 90% at the inside of the weld and 30 to 40% or more at the surface of coating 30. The transition from low concentration to concentration occurs over a distance of approximately 20-30 um. It should be noted that after mixing during ESD, the “nickel” layer may be a mixture, or mixed alloy, that is nonetheless predominantly copper, but has a higher concentration of nickel than in the adjacent parent metal of substrate 20; or, more generally, the base metal composition or elements may dominate coating layer 30, but layer 30 will have the highest concentration of the composition or elements of the material of rod 44, even if that concentration is out-weighed by the material of substrate 20.

Once another layer or sub-layer is deposited, again, the mixed alloy of the second sub-layer will tend to be lowest toward substrate 20 and higher toward the exposed surface of coating 30 (or of second coating 50, as may be). Accordingly, the deposition of subsequent layers of intermediate material to build up a thicker inter-layer may also tend to build up a gradation of concentration shift as between the composition of substrate 20 and the coating composition of rod 44. Again, it may be noted that even in the outer layer, i.e., second layer 50, the concentration of copper, for example, may exceed the concentration of silver, and may exceed the concentration of nickel as well. Similarly, the concentration of nickel may exceed the concentration by wt. % of silver. Nonetheless the outer layer or portion of the resultant metallurgical structure will be referred to nominally as the “silver” layer, and the interlayer is referred to nominally as the “nickel” layer. In other embodiments, second layer 50 is aluminum, and may be referred to nominally as an “aluminum” layer, notwithstanding that the predominant element of the resultant “aluminum” layer is copper.

Another feature that was noted during testing was that peening of the nickel, silver and aluminum layers was effective in tending to close up cracks and porosity in the deposited layers, leading to a more consistent metallurgical structure. Peening might typically occur after a cycle of deposition, with the discharge current off, as the surface is cooling and still relatively soft in terms of an ability to be plastically deformed. The peening might occur at a frequency of 30% to 50% of the rotational frequency of rod 44, for example.

Further, in some embodiments the coatings were deposited using a synthetic AC power supply. In particular, in a 75% AC signal, three pulses are sent with reverse electrical polarity, and a fourth signal is sent with straight polarity. The 25% straight polarity signal is used to cause the weld surface to scavenge, i.e., to remove oxides or other materials. This produced acceptable results. However, the use of DCEP, i.e., direct current electrode polarity for all pulses tended not to remove as much of the base copper material, and tended to leave a smoother surface. That is, one reason for providing a silver surfacing to a copper electrode block is that silver has better arcing resistance. This means that, in use, the silver surface may be less prone to arcing, or, to the extent that there is arcing less damage may be done, i.e., when arcing occurs, may be less prone to the surface erosion, or pitting, or loss of materials that may be associated with arcing than is copper. However, the use of straight polarity to clean the weld surface during ESD deposition also tends to yield greater loss of the base metal copper material to arcing during the process of deposition of the silver than may be helpful. The use of DCEP may tend not to have this effect so strongly. Where erosion resistance is desired, the silver coatings can be doped with Tungsten Carbide.

Further still, ESD layers were deposited in both shielded and unshielded conditions. In the shielded embodiments Argon or Helium, or both were used as the shielding gases. Where shielding gas is used, the coating can be formed with a lower energy input. However, the resultant coating appeared generally to be thinner, and the use of a shielding gas was not a necessary requirement to obtain a satisfactory finished layer. Shielding gas may be used for deposition of silver. Conversely, shielding gas may be omitted when depositing nickel. That is, while shielding gas can be used at all times, it may be more beneficial to use shielding gas when depositing silver than it is when depositing nickel.

A second example involves deposition of tungsten carbide on steel alloys. The tungsten carbide may be in the form of a welding rod 44 of a sintered mixture of tungsten carbide and cobalt. The concentrations of tungsten carbide are relatively high, and would tend to be difficult to achieve with conventional welding, if they could be achieved at all. The tungsten carbide, WC, (or, titanium carbide, TiC, or titanium-diboride, TiB2) may be deposited on the parent metal of substrate 20, e.g., for the purpose of giving it a hard, wear resistant surface. However, ESD of tungsten carbide may tend to yield droplets, or splatters of WC on the surface of the steel. The droplets or splatter may tend to be discontinuous. This may not be fully satisfactory. Accordingly, a second layer may be deposited.

In one example, first layer or coating 30 is WC, and second layer or coating 50 is nickel. That is, once the WC has been deposited by ESD, a second layer is deposited of nickel, and then a further layer 70 of WC is laid down on top of the nickel. In this approach, the nickel tends to fill the gaps in the initial WC layer, welds well with the exposed steel, wherever it may be, and tends also to provide a more welcoming alloy for the subsequent deposition of WC in layer 70 than the original steel alloy. I.e., a nickel alloy may tend to be more welcoming of tungsten carbide (or, TiC or TiB2) than the original steel alloy substrate. Depending on the thickness desired, ESD may be used to add successive layers or sub-layers of nickel and tungsten carbide to such extent as may be appropriate, with peening with any or all of the layers as may suit. ESD by its nature allows quite high concentrations of tungsten carbide (e.g., 50% or more by wt. %, or 40% to 70% by wt %, more generally) to be deposited on the surface of the object work piece. The use of nickel layers may tend to reduce the overall concentration of tungsten carbide in the surface of the resultant product. On the other hand, the use of nickel facilitates the deposition of subsequent layers of tungsten carbide, and may tend to make it easier to form a tungsten carbide layer with fewer or smaller defects, such that despite a reduction in concentration, the overall amount of tungsten carbide in the coating layer may be higher, or the overall layer may be thicker, or both, such as may tend to yield a surface with greater potential to provide a longer wear life.

In an alternate, layer 30 is a “nickel” layer, and layer 50 is the tungsten carbide layer. That is, the user may choose to dispense with the initial attempt to lay tungsten carbide on the steel alloy directly, and may start, instead, with a first step of depositing a layer of nickel on the steel, followed by a second step of depositing a layer of tungsten carbide. This approach recognizes that the nickel tends to bond well with the steel, and nickel is known to be more welcoming of the tungsten carbide than is the steel. Further layers of nickel and tungsten carbide may follow, as before. Any one or more of those layers may be peened.

In any event, it may be desired that the weld of interlayer 30 to substrate 20 be a low energy weld, such as may tend to result in a weld that, while forming an atomic level bond, is nonetheless substantially free of a heat affected zone (HAZ), and that may tend to leave the alloys of the materials with the material properties for which its use was desired in the first place. The use of a low-energy coating process such as ESD may tend to discourage the precipitation of alloy elements. To that end, an ESD process is used to provide coating 30 on substrate 20. That is, ESD is used as a process of depositing an interlayer as part of a method of depositing a contact surface on an electrode body, such as a copper electrode; or it may be used to permit deposition of an otherwise challenging material, such as tungsten carbide elements of a wear surface to surface steel alloy, or to other structural components. This process or method is a low-energy process, i.e., with a low heat input that may tend to improve the quality of the bonding to copper, or steel, or other substrates, as the case may be.

More generally, it can be said that in its various embodiments and examples, the method of surface treatment being discussed herein employs an electrically conductive metal alloy material. It may be applied to a metal, or metal alloy. It may be applied to weldable semi-conductor alloys or to weldable metal-based composites such as TiC and TiB₂. It contemplates that the work piece of substrate 20 in various embodiments is formed of a material that includes at least one of (a) Nickel; (b) Chromium; (c) Molybdenum; (d) Titanium; (e) Tungsten; (f) Iron (g) Steel (h) Aluminum and Aluminum alloys; and (i) Niobium; (j) Magnesium; and (k) Cobalt, (l) Copper, or alloys thereof. The material may also include one or more of Carbon, Cobalt, Manganese, Vanadium, or other metals that may be found in steel alloys, Nickel-based alloys, Aluminum alloys or Copper alloys. In some examples, the work piece of substrate 20, by weight is at least one of (a) 10% Ni; (b) 5% Chromium. In some cases the work piece is made of a metal alloy of which Nickel, Chromium, and Iron and the largest constituents by wt. %. In some alloys it is more than 40% Nickel, and more than 10% Chromium, two constituents being the primary constituents of the alloy and forming a majority of the material. In some instances Nickel and Chromium form more than 70% of the alloy by weight. In other instances, the work piece is formed of a material that, by weight %, is at least one of (a) 10% Cobalt; (b) 5% Chromium. In another the work piece, by weight % is at least one of (a) 10% Titanium; (b) 2% Aluminum. In still other instances, the work piece is made of a metal alloy of which Cobalt and Chromium are the largest constituents by wt. %. In other embodiments the work piece is made of a metal alloy of which Titanium is the largest constituents by wt. %. In some instances the coating material is formed of an alloy that, by weight, has a higher percentage of Nickel than any other constituent.

In the examples, the ESD coating material of rod 44 is formed of an alloy including at least one of (a) Nickel; and (b) Chromium. In some embodiments Nickel is, by wt. %, the largest component. In some examples, the material for deposition from the welding rod as the coating is formed of an alloy that includes at least one of (a) Nickel; (b) Chromium; (c) Iron; (d) Tungsten; (e) Cobalt; and (f) Titanium. In some instances the coating material is formed of an alloy that, by weight, has a higher percentage of Nickel than any other constituent. It may be nearly pure Nickel, i.e., more than 90% by weight. In other embodiments the coating material is made of a metal alloy of which Iron is the largest constituents by wt. %. In other embodiments the coating material is made of a metal alloy of which Cobalt is the largest constituents by wt. %. In still others the coating material is made of a metal alloy of which Titanium is the largest constituents by wt. %. An Inconel 718 electrode may be used. Ultra high purity argon shielding gas can be delivered coaxially around the electrode during deposition, and ESD parameters of 100 V, 80 μF and 150 Hz can be used. The method could have an initial discharge voltage in the range of 30 to 200 V.

Once however many layers or sub-layers of coating 30 have been applied, the second welding process occurs in securing second layer 50 to coating 30. Both processes may be undertaken with relative control over the area and size of the weld (i.e., over a pre-specified footprint), and of the total energy input, or total energy per unit area of coating. The total energy input may be set according to the surface area of the weld to be made, and the thickness of the material of the weld. In general, the thickness of coating 30 may be intended to be thicker than, or comparable to, the depth of the second coating or layer 50. Melting may occur at the interface of second layer 50 (or third layer 70, as may be) with coating 30, but it is not intended that so much energy should be input as to cause substantial re-melting at the welded interface between coating 30 and substrate 20, or if such re-melting should occur, that it should be minor, and limited in extent; and even if re-melting should occur, coating 30 may nonetheless form a barrier or obstacle to unwanted mixing or precipitation of materials. Again, the time duration of a resistance weld or of a precision laser weld is quite limited.

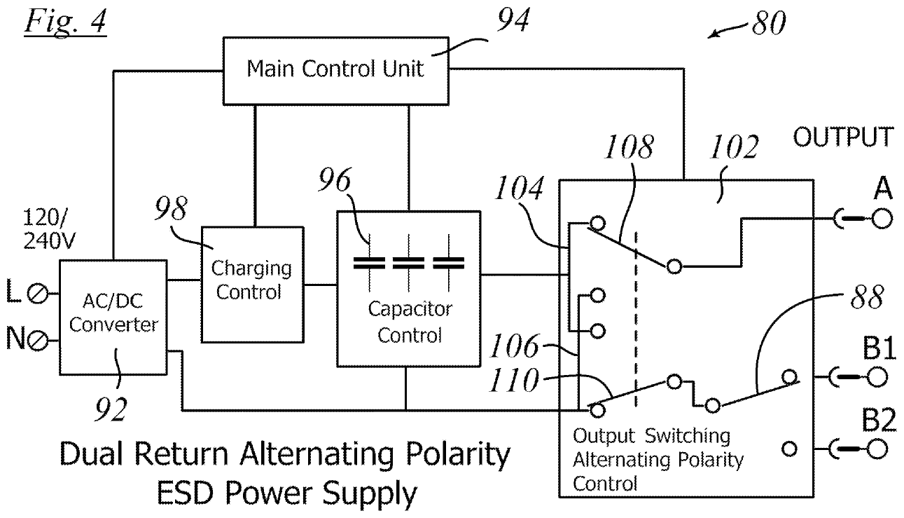

Further, as in FIGS. 3 and 4, a power supply 80 may supply power that is either Direct Current Electrode Positive, or a Dual Return Alternating Polarity. Power supply 80 may have a third terminal that is connected by a wire or cable 86 to second location on substrate 20. During operation, power supply 80 has an internal switch 88 that connects either the first or second “B” terminal (i.e., B1 or B2) to permit the flow of current. The discharge will then tend to accumulate on and build either side through the arc to the point of least resistance. Over time a fillet 90 may build as rod 44 moves long under its vibrating drive.

That is, while the use of a digitally-generated reversing DC sequence of pulses (or, alternatively, a “synthetic AC” wavetrain) may be applicable in a variety of ESD, or low energy welding, generally, FIG. 4 shows a three-pole apparatus to which reference may be made when considering the use of reversing or alternating ESD processes. Without changing polarity, a purely DCEP chain of pulses may be used. In FIG. 4 power supply, P.S., 80 receives line voltage, or such other source electrical power as may be as indicated at L (line voltage) and N (neutral or ground) such as may be 120 V, 60 Hz; or 220 V, 50 Hz, and converts it to a suitable output form. That conversion may involve rectification to a DC signal, and accumulation of charge on capacitor banks. Power supply 80 has three output terminals T1, T2 and T3, respectively. T1 is connected to the welding handle or applicator 40, and ultimately to the welding electrode 44, identified notionally as handle-and-electrode-assembly applicator 40 by a conductor such as indicated as cable 82. T2 is electrically connected to substrate 20 and T3 is electrically connected to second object 50, as indicated by cables 84, 86 respectively.

ESD, or low energy welding, may be commenced by applying a voltage discharge across T1 and either of T2 or T3. The welding rod and handle assembly of applicator 40 may be very finely guided along the site at which a weld filet is desired between first object 20 and second object 50 by an automated welding electrode holder, carriage, or robot, symbolized by item 40. Alternatively, the handle may be held and moved manually.

Whether for similar or dissimilar metals, ESD, i.e., low energy welding, may be used to build up a coated layer, i.e., interlayer coating 30, of however many layers 36, 38, etc. It may then be used to build up subsequent layers 50, 70 etc., as may be. This may take several passes, or coating sessions. The process may occur in an inert atmosphere, or in the presence of a supplied flow of shielding gas using suitable apparatus. It may occur using a hand-held apparatus or a robot mounted welding electrode. When completed, the resultant weld may have only a small heat affected zone, or no appreciable heat affected zone. The weld may be very close to near net size, and may not require grinding or other surface finishing.

During operation, power supply 80 provides the welding electrode with current. As seen in the schematic drawing of FIG. 4, power supply 80 may be a polarity switching electro-spark discharge power supply. It has an input interface in the form of an input power converter 92 which converts line voltage to voltage usable within the power supply. The input power may be alternating current, e.g., 120 V, 60 Hz or 240 V, 50 Hz; or it may be a DC supply voltage, such as 150 V from another power supply to which power supply 80 may be connected as a power interface box, or converter. Input power converter 92 may be a two-terminal input having a first input L, for line voltage, and a second terminal N for neutral or ground. Power supply 80 also has a main control unit 94. Main control unit 94 may also be termed, or may include, a central processing unit which may have the form of a circuit board and ancillary components. Main control unit 94 is programmed to determine the nature of the input power signal received at converter 92, and to convert it accordingly into rectified DC at an appropriate voltage for charging the capacitors of the capacitor bank (or banks) 96. Capacitor banks 96 may include a single set of capacitors, two sets of capacitors, or more sets of capacitors. Main control unit 94 is also controls the charging of the capacitors of capacitor banks 96, and monitors their stored voltage levels, setting those voltage levels according to the voltage required for the programmed output pulses. This may be done by controlling the positive voltage output from input power converter 92 using a charging control 98 connected in series between input power converter 92 and capacitor banks 96. Main control unit 94 also controls discharge switching connected between the positive side of capacitor banks 96 and the input positive terminal of a polarity switching control unit 102.

Polarity switching control 102 has two internal pairs of terminals 104, 106, the first being positive, the other being negative, neutral, or ground. Polarity switching control 102 also has two internal throws, or switches, 108, 110 that are slaved, i.e., linked, together. Control unit 94 operates switches 108, 110, connecting them alternately to the first, second and third discharge power outlet terminals, seen as “A”, “B1” and “B2”. In the normal, or reverse polarity context, terminal pair 104 is connected through switch 108 to terminal “A”. Similarly, the other side of terminal pair 106 is connected through switch 110 to one or the other of terminal “B1” and terminal “B2”. In this configuration a “positive” charge pulse will be sent to welding electrode applicator 40. Alternatively, in the opposite position, main control unit 94 sets the switches such that the positive side, of terminal pair 104, is connected through switch 110 to one or the other of terminal “B1” and terminal “B2”, and the negative, neutral, or ground side, of terminal pair 108, is connected through to terminal “A”, thus reversing the discharge polarity. That is, main control unit 94 operates to control the switching of alternating polarity switches 108 and 110, and to control the switching of alternate output control switch 88 which moves between alternate outputs “B1” and “B2”.

In operation, the output switching of FIG. 4 is controlled by main control unit 94. Although the synthetic DC electrical signals, or electrical pulses, however they may be called, may not have the same period or pulse duration, they may have an average rate of discharge, or an accumulated number of signals per elapsed unit of time. For example, there may be 10 to 10,000 signals, or discharges, over a period of 1 second. In some embodiments this rate may be in the range of 1500 discharges per second to 5000 discharges per second. This can be termed a frequency range of 10 Hz to 10 kHz, except that the individual pulses are not cyclic, but rather are discrete, programmed, DC discharges. The operator may program the power supply by adjusting the discharge voltage levels, and the overall energy discharge per unit time (effectively, the pulse voltage, total charge, and the number of pulses per second) to govern the overall heat input into the workpiece interface (e.g., to avoid over-heating). However, once having set those external input parameters, the main control unit is programmed electronically to implement the selections made by the operator.

The operator may also select whether straight polarity is to be employed, and to what extent. Alternatively, the deposition apparatus may sense the rate of consumption of the welding electrode, and, when that rate of consumption has fallen relative to the initial rate by a datum amount, such as ⅕ or ¼ (i.e., to ⅘ or % of the original rate), to initiate a cleaning cycle using straight polarity. The cleaning cycle may include a series, or burst, of straight polarity pulses, or it may be implemented by alternating between forward or straight (i.e., cleaning) and reverse (i.e., deposition) pulses. The number of straight pulses may be different from, (i.e., not equal to), the number of reverse pulses. For example, the ratio of cleaning pulses to deposition pulses may be in the range of 1:1 to 1:10.

In some examples, the second object may itself be built up on top of the interlayer, by an ESD process. That is, the process may start by using an ESD deposition to lay an interlayer on the first object. For example, the first object may be Chromoly with a Tungsten Carbide-Cobalt WC—Co surface layer. A nickel interlayer may be deposited on the Chromoloy without substantially altering the underlying metal structure. The nickel may be Nickel 99. The second object may be something that is, or that includes a composition that is not always easy to weld. In one example it is an alloy of Tungsten Carbide (WC) and Cobalt, Co. The WC—Co object, or, an object having a WC—Co facing, is them welded to the interlayer. Nickel is a suitable medium for an interlayer in this example. The interlayer of Nickel separates the WC—Co materials of the first object, being the Chromoly in this example, from the WC—Co coating of the second object in this example. TiC could also be used as the second object. In this example, the interlayer is being used to build up a thicker Layered wear coating on the Chromaloy part.

In one example, there was a first layer of Tungsten Carbide deposited using a power supply operating at 100V initial discharge voltage, 200 uF Capacitance, 150 Hz signal, over a duration of 400 s to cover a surface patch of 1 cm sq. The second layer of Ni99 was deposited using a 120 V initial voltage, 120 uF capacitance, operating at 150 Hz for 300 seconds. The third layer was again Tungsten Carbide, deposited at an initial voltage of 100 V, 200 uF 150 Hz for 400 seconds. Notably for a processing time totaling 1100 s, the sample was significantly heated and would likely exhibit some heat effects. This procedure achieved a satisfactory coating thought to provide a relatively consistent coating from which wear resistance might be expected. Upon examination, the deposition layer appeared to be a multilayered coating having a total coating of approximately ˜250 um, whereas a previous coating was more typically 50 um for a standalone WC/Co coating without an interlayer.

Defects may be present in the coatings. Significant heat buildup and CTE differences can result in post coating hot cracking, delamination, and poor adhesion during ESD. After cooling, a subsequent layer of nickel may be applied, followed by a subsequent surfacing layer of cermet, such as Tungsten Carbide.

To summarize, as disclosed there is a method of forming a welded connection between a first object 20 and a second object 50. First object 20 and second object 50 are electrically conductive. First object 20 may be a work piece or substrate. Second object 50 may be the desired final surface coating that is to be applied to first object 20. The method includes coating a first region of first object 20 with an electro-spark discharge coating 30, which may be referred to as an interlayer. The second object is deposited by ESD on top of coating 30 of first object 20.

In another feature, first object 20 is made of a different material from second object 50. In another feature, first object 20 is made of a first material; second object 50 is made of a second material; ESD coating 30 is made of a material that is different from the first material; and ESD coating 30 is made of a material that is different from the second material. In another feature, the second material is different from the first material. In another feature, first object 20 is a steel alloy. In a further feature, one of the coating layers is nickel. In another feature, one of the coating layers is a cermet. In still another feature the cermet is tungsten carbide.

The method can include coating of first object 20 with more than one pass of ESD material to build a coated region of a set thickness. The method can include depositing a first layer and a second layer of ESD material on first object 20, and the first layer is made of a different composition of material than at least one subsequent layer. In another feature, the method includes alternately discharging electrical current through first object 20 and second object 50 to build a weld fillet of ESD material between first object 20 and said second object 50. In another feature, the method includes forming at least a second electro-spark discharge coated region on the first object and welding the second object to the first object at least at the first ESD coated region and at the second ESD coated region. Further the method can include forming at least a second ESD coated region on first object 20, and subsequently welding a third object 70 to the second ESD coated region. In a particular example, the method is used to form either a silver-rich or an aluminum-rich surface coating on a copper substrate of an electrical contact. That is, the welded assembly is an electrical contact, the first material is predominantly copper, and the second material is silver or an alloy of silver. In an alternate particular example, the method is used to form a tungsten carbide rich surface layer on a steel alloy. That is, the first material is a steel, and the second material includes tungsten carbide deposited to form a wear surface on the steel.

Various combinations have been shown, or described, or both. The features of the various embodiments may be mixed and matched as may be appropriate without the need for further description of all possible variations, combinations, and permutations of those features. The principles of the present invention are not limited to these specific examples that are given by way of illustration. It is possible to make other embodiments that employ the principles of the invention and that fall within its spirit and scope of the invention. Since changes in and or additions to the above-described embodiments may be made without departing from the nature, spirit or scope of the invention, the invention is not to be limited to those details, but only by the appended claims.

I claim:

1. A method of coating a substrate, the substrate being electrically conductive, wherein said method comprises:
coating a first region of the substrate with an electro-spark discharge (ESD) coating of a material that is different from the substrate to form an interlayer;
coating the interlayer with a subsequent layer of a material that is different from the interlayer; and
peening at least one of (a) the interlayer; and (b) the subsequent layer as part of the coating process.

2. The method of claim 1 wherein both the interlayer and the subsequent layer are subject to peening.

3. The method of claim 1 wherein the interlayer is deposited using polarity-switching alternating current.

4. The method of claim 1 wherein the subsequent layer is deposited using direct current electrode polarity.

5. The method of claim 1 wherein at least one of (a) said interlayer; and (b) said subsequent layer is made of at least a first sub-layer and a second sub-layer of material deposited by ESD on the first sub-layer.

6. The method of claim 1 wherein said interlayer is a first layer, said subsequent layer is a second layer, and a third layer is deposited by ESD on said second layer.

7. The method of claim 1 wherein one of:
(i) said substrate is made of a material that is predominantly copper, and said subsequent layer is made using a welding rod deposition material that is predominantly silver; and
(ii) said interlayer is made using a welding rod deposition material that is one of (a) nickel; and (b) an alloy whose dominant constituent by wt. % is nickel.

8. The method of claim 1 wherein said substrate is made of a material that is a steel alloy, and said subsequent layer includes tungsten carbide.

9. The method of claim 1 wherein:
said first object is made of a first material;
said subsequent layer is made of a second material;
said electro-spark discharge coating is made of a material that is different from said first material; and
said electro-spark discharge coating is made of a material that is different from said second material.

10. The method of claim 9 wherein at least one of:
(a) said second material differs from said first material; and
(b) said first object is a steel alloy.

11. The method of claim 7 wherein any one of:
(a) said first object is made of a steel alloy and said second material is a cermet; and
(b) said first object is made of a copper alloy and said second material is one of silver and aluminum.

12. The method of claim 1 wherein said substrate is made of a first material, said interlayer is made of a second material, and said subsequent layer is made of a third material; said first and third materials have higher thermal conductivities than said second material.

13. The method of claim 12 wherein:
said second material has a thermal conductivity of less than 100 W/MK; and
said first and third materials have thermal conductivities of greater than 100 W/MK.

14. The method of claim 1 wherein said method includes at least one of:
(a) coating of said first object includes making more than one pass of electro-spark discharge deposited material on said first object to build a coated region of a set thickness;
(b) making at least a first layer and a second layer of electro-spark discharge deposited material on said first object, said first layer being made of a different composition of material than at least one subsequent layer; and
(c) forming at least a second electro-spark discharge coated region on said first object, and subsequently welding another subsequent layer of a different material to said second electro-spark discharge coated region.

15. The method of claim 1 wherein the method is used to form one of:
(a) a silver-rich surface coating on a copper substrate of an electrical contact;
(b) an aluminum-rich surface coating on a copper substrate of an electrical contact; and
(c) a tungsten carbide rich surface layer on a steel alloy.

16. A welded assembly comprising:
a first material; a second material; and an electro-spark discharge interlayer;
said electro-spark interlayer being formed on said first material;
said second material being deposited by ESD on said interlayer;
said interlayer having a peened surface; and said second layer having a peened surface.

17. The welded assembly of claim 16 wherein at least one of:
(a) said electro-spark discharge interlayer has a different composition from said first and second materials;
(b) said interlayer includes a second ESD coating applied on top of said first ESD coating; and
(c) said interlayer includes a second ESD coating applied on top of said first ESD coating and the material deposited in the second ESD coating is different from the material deposited in the first ESD coating.

18. The welded assembly of claim 16 wherein said interlayer is subject to peening, and said peening includes impacting said first region with a mean impact density in the range of between 0 and 30,000 impacts per cm².

19. The welded assembly of claim 16 wherein said substrate is a work piece formed of a material that includes at least one of (a) Nickel; (b) Chromium; (c) Molybdenum; (d) Titanium;
(e) Tungsten; (f) Niobium; (g) Iron; (h) Aluminum; and (i) Copper; (j) Magnesium; and (k) Cobalt.

20. The welded assembly of claim 19 wherein any one of:
(a) said substrate, by weight is at least one of (a) 10% Nickel; (b) 5% Chromium;
(b) said substrate, by weight is at least one of (a) at least 90% Copper; (b) 90% Steel;
(c) said second material, by weight is at least one of (i) 90% silver; (ii) 90% Aluminum;
and (iii) 40% Tungsten Carbide;
(d) said work piece is made of a metal alloy of which Nickel and Chromium are the largest constituents by wt. %;
(e) said interlayer is formed of an alloy that, by weight, has a higher percentage of Nickel than any other constituent; and
(f) iron is, by wt. %, the largest component of said alloy of said substrate.
